(19) United States
(12) Patent Application Publication
(10) Pub. No.: US 2008/0219735 A1
(43) Pub. Date: Sep. 11, 2008

(54) Printhead Assembly for a Credential Production Device

(75) Inventor: Ted M. Hoffman, Eden Prairie, MN (US)

Correspondence Address: WESTMAN CHAMPLIN & KELLY, P.A., SUITE 1400, 900 SECOND AVENUE SOUTH, MINNEAPOLIS, MN, 55402-3244, US

(73) Assignee: FARGO ELECTRONICS, INC., Eden Prairie, MN (US)

(21) Appl. No.: 11/683,827

(22) Filed: Mar. 8, 2007

(51) Int. Cl. B41J 11/20

(52) U.S. Cl. 400/58

(57) ABSTRACT

A credential production device is disclosed. The credential production device includes a frame and a printhead assembly. The printhead assembly includes a support member, a pivotable coupling, a printhead and an actuation mechanism. The support member has a first end and a second end. The pivotable coupling attaches the first end of the support member to the frame. The printhead is coupled to the second end of the support member. The actuation mechanism is coupled to the support member between the first end and the second end. The actuation mechanism is configured to pivot the support member about the frame to move the printhead form an idle position to a print position.

### CROSS-REFERENCE TO RELATED APPLICATIONS

This application incorporates herein by reference in their entirety the following applications filed on even date herewith: U.S. patent application Ser. No. ______ entitled “SUBSTRATE FEEDING IN A CREDENTIAL PRODUCTION DEVICE” having inventors Ted M. Hoffman, Jeffrey L. Stangler, John P. Skoglund and Tony Nauth and attorney docket number F12.12-0164; U.S. patent application Ser. No. ______ entitled “CARD HOLDER FOR A CREDENTIAL PRODUCTION DEVICE” having inventors Ted M. Hoffman, Jeffrey L. Stangler and John P. Skoglund and attorney docket number F12.12-0165; U.S. patent application Ser. No. ______ entitled “CREDENTIAL PRODUCTION PRINT RIBBON AND TRANSFER RIBBON CARTRIDGES” having inventor Ted M. Hoffman and attorney docket number F12.12-0166; U.S. patent application Sr. No. ______ entitled “CANTILEVERED CREDENTIAL PROCESSING DEVICE COMPONENT” having inventors Ted M. Hoffman and Thomas G. Gale Jr. and attorney docket number F12.12-0169; U.S. patent application Ser. No. ______ entitled “CREDENTIAL PRODUCTION DEVICE HAVING A UNITARY FRAME” having inventors Ted M. Hoffman and James R. Cedar and attorney docket number F12.12-0170; and U.S. patent application Ser. No. ______ entitled “INVERTED REVERSE-IMAGE TRANSFER PRINTING” having inventors Ted M. Hoffman, Jeffrey L. Stangler, John P. Skoglund, Thomas G. Gale Jr. and Tony Nauth and attorney docket number F12.12-0171.

### FIELD OF THE INVENTION

The present invention is generally directed to a credential production device. More particularly, the present invention is directed to a printhead assembly used in processing a credential substrate in a credential production device.

### BACKGROUND OF THE INVENTION

Credential products include, for example, identification cards, driver's licenses, passports, and other valuable documents. Such credentials are formed from credential substrates including paper substrates, plastic substrates, cards and other materials. Such credentials generally include printed information, such as a photo, account numbers, identification numbers, and other personal information that is printed on the credential substrates using a print consumable, such as ink and ribbon.

Credential processing devices process credential substrates by performing at least one step in forming a final credential product. One type of credential production device is a reverse-image credential production device. Reverse-image credential production devices generally include a printing section and an image transfer section. The printing section utilizes an intermediate transfer film or transfer ribbon, a print ribbon and a printhead. The printhead is typically a thermal printhead that operates to heat different colored dye panels of a thermal print ribbon to transfer the colored dye from the print ribbon to a panel of transfer film to form the image thereon. After the printed image on the transfer film is registered with a substrate, a heated transfer roller of the image transfer section transfers the image from the transfer film or transfer ribbon to a surface of the substrate.

Conventional reverse-image credential production devices are typically large, cumbersome and complicated machines where improvements to these types of machines are in continuous demand. For example, there is a continuous demand for improving the functionality of credential processing device components, such as printheads, transfer rollers, platens and other types of components used in processing the credential product in the credential production device, while reducing the amount of space needed for such devices.

Embodiments of the present invention provide solutions to these and other problems, and offer other advantages over the prior art.

### SUMMARY OF THE INVENTION

Embodiments of the invention are directed to a credential production device. One embodiment of the credential production device includes a frame and a printhead assembly. The printhead assembly includes a support member, a pivotable coupling, a printhead and an actuation mechanism. The support member has a first end and a second end. The pivotable coupling attaches the first end of the support member to the frame. The printhead is coupled to the second end of the support member. The actuation mechanism is coupled to the support member between the first end and the second end. The actuation mechanism is configured to pivot the support member about the frame to move the printhead form an idle position to a print position.

In accordance with another embodiment, the credential production device includes a supply of print ribbon, an image receiver being adjacent to the supply of print ribbon and a printhead assembly. The printhead assembly includes a support member, a pivotable coupling, a printhead and an actuation mechanism. The support member includes a first end and a second end. The pivotable coupling is attached to the first of the support member to a frame. The printhead is coupled to the second end of the support member. The actuation mechanism is coupled to the support member between the first end and the second end. The actuation mechanism is configured to pivot the support member about the frame to move the printhead from an idle position to a print position.

Embodiments of the invention also provide a method of engaging a printhead assembly to print in a credential production device. The method provides a frame and provides a printhead assembly. The printhead assembly includes a support member having first and second ends, a pivotable coupling attached to the first end of the support member and a printhead coupled to the second end of the support member. The method pivots the support member about the frame to move the printhead along an arc from an idle position to a print position.

### BRIEF DESCRIPTION OF THE DRAWINGS

FIG. 1 is a perspective view of a credential production device under embodiments of the invention.

FIG. 2 is an exploded perspective view of the credential production device of FIG. 1.

FIG. 3 is a simplified schematic diagram of the credential production device illustrated in FIGS. 1 and 2.

FIG. 4 illustrates a rear plan view of a print ribbon cartridge adjacent a transfer ribbon cartridge under embodiments of the invention.

FIG. 5 illustrates a perspective view of the credential production device of FIGS. 1 and 2 and having a printhead assembly under embodiments of the invention.

FIG. 6 illustrates a schematic representation of the printhead assembly in FIG. 5 in an idle position.

FIG. 7 illustrates a schematic representation of the printhead assembly of FIG. 5 in a print position.

FIG. 8 illustrates a perspective view of the printhead assembly of FIG. 5.

### DETAILED DESCRIPTION OF THE PREFERRED EMBODIMENTS

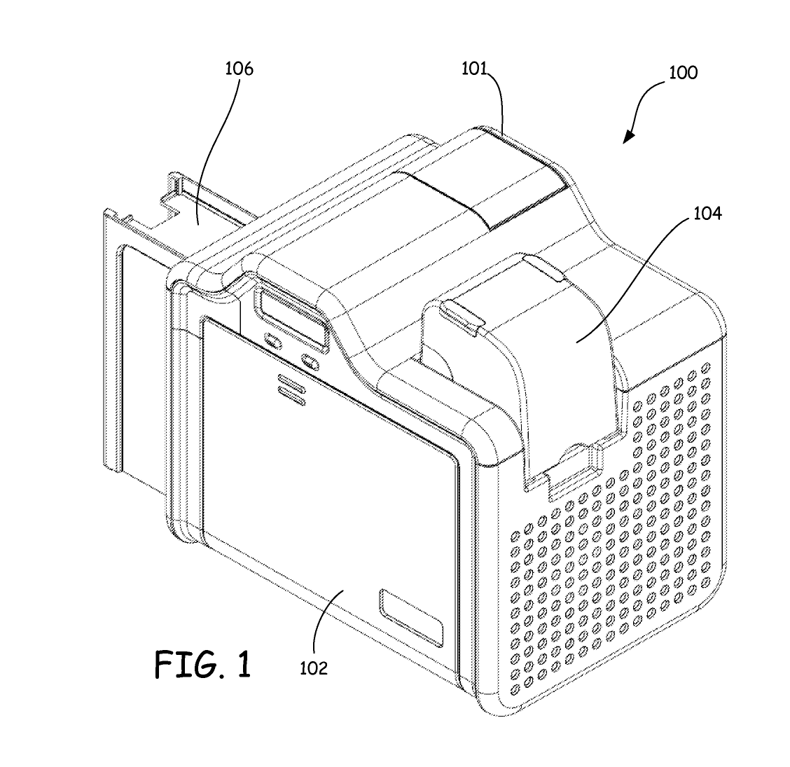

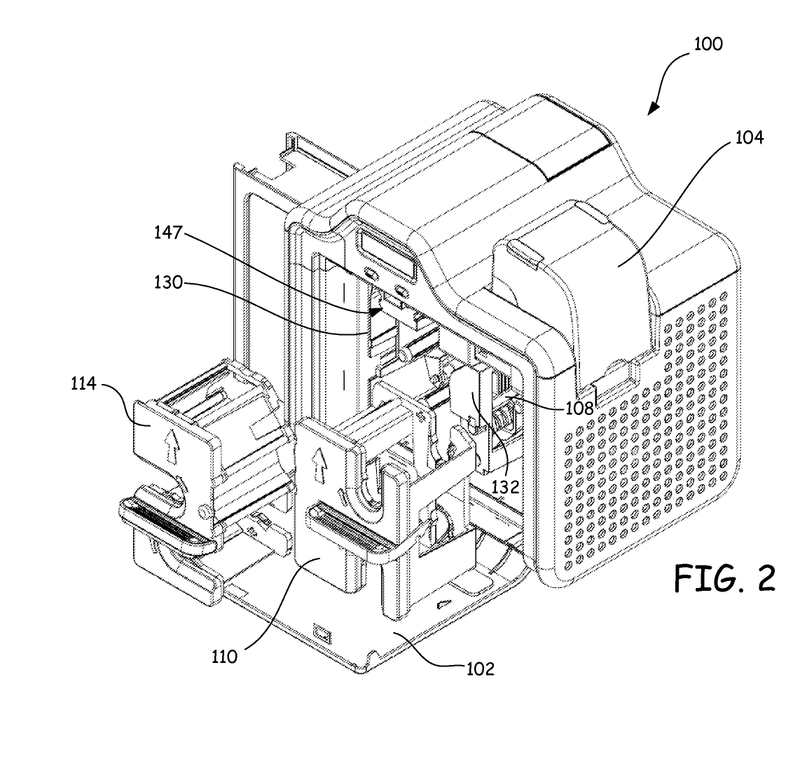

FIGS. 1 and 2 illustrate perspective views of a credential production device 100. FIG. 1 illustrates an exterior view of credential production device 100 and FIG. 2 illustrates an exploded view of credential production device 100. Embodiments of the disclosure pertain to credential production device 100 as being a reverse-image printer and, therefore, embodiments of the disclosure pertain to a printhead assembly used for printing from a print ribbon to a transfer ribbon in a reverse-image printer. However, it should be understood that embodiments of the printhead assembly in the disclosure can also be used in other types of credential production devices such as non-reverse-image credential printing devices and credential laminating devices.

Credential production device 100 provides inverted reverse-image transfer printing using a transfer roller and other production components that are inverted relative to a position of production components in a conventional reverse-image production device with respect to a processing path. With the inverted transferring of imaged film to a substrate, credential production device 100 is able to locate production components below the processing path. Such a configuration aids in making credential production device more compact, especially in height, as well as simplifies a processing path of which a credential substrate is transported.

In the embodiment illustrated in FIG. 1, credential production device 100 includes an enclosure 101 having a front panel 102. Credential production device 100 utilizes a substrate cartridge 104, a substrate transport mechanism (not illustrated in FIG. 1) and a credential output hopper 106. In addition to the location of production components in credential production device 100 being below a substrate path, configurations of many production components within credential production device 100 allow the device to be more compact than conventional credential production devices.

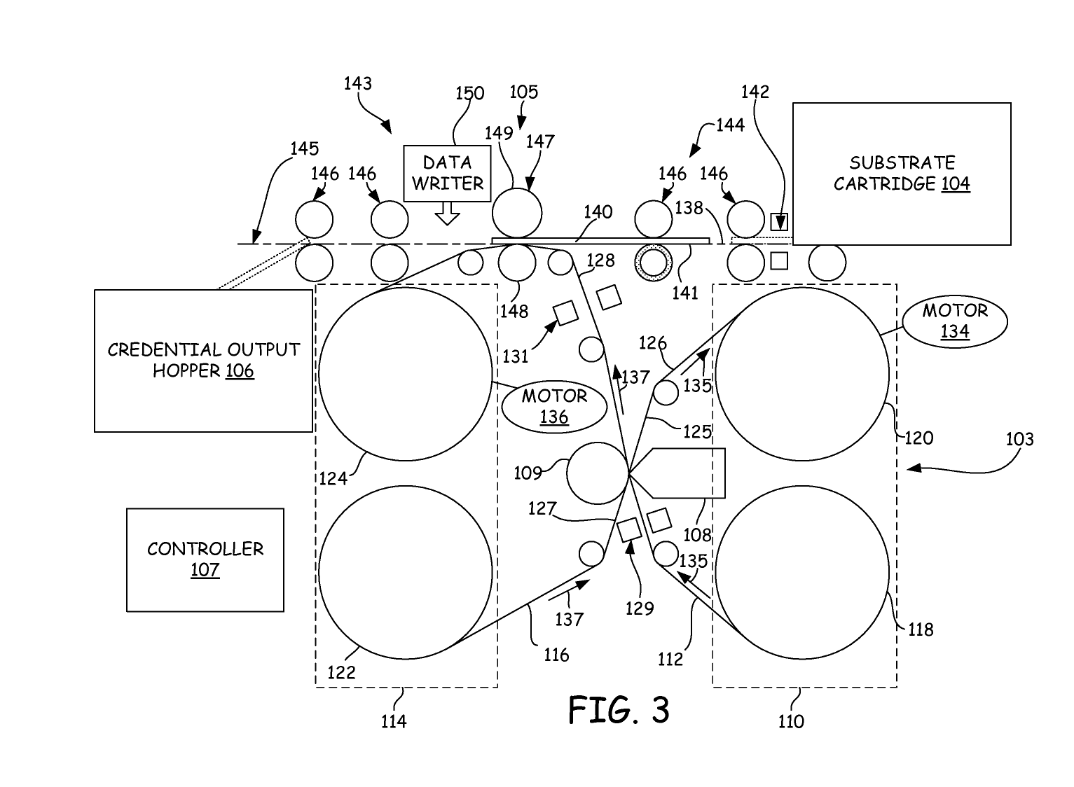

In FIG. 2, front panel 102 is removed to more clearly describe main production components internal to credential production device 100, and FIG. 3 also illustrates a simplified schematic diagram of various production components internal to credential production device 100 that are not easily shown in FIG. 2. In general, credential production device 100 includes a printing section 103 and an image transfer section 105. A controller 107 generally controls the components of credential production device 100 to perform various operations including printing, imaging transfer, sensor calibration and other operations.

In one embodiment, printing section 103 includes a printhead 108, a print platen 109, a print ribbon cartridge 110 for supporting a print ribbon 112 and a transfer ribbon cartridge 114 for supporting a transfer ribbon 116. As illustrated in FIG. 2, cartridges 110 and 114 are releasable and removable from credential production device 100 for loading and unloading print ribbon 112 and transfer ribbon 116. Print ribbon 112 (e.g., dye sublimation print ribbon) is wound about a supply spool 118 and a take-up spool 120. Transfer ribbon 116 is wound about a supply spool 122 and a take-up spool 124. Print ribbon 112 includes a first side 125 and a second side 126 opposite the first side. When print ribbon 112 is wound about spools 118 and 120, first side 125 faces the interior of print ribbon cartridge 110 and second side 126 faces transfer ribbon cartridge 114. Transfer ribbon 116 includes a first side 127 and a second side 128 opposite the first side. When transfer ribbon 116 is wound about spools 122 and 124, first side 127 faces the interior of transfer ribbon cartridge 114 and second side 128 faces print ribbon cartridge 110.

In one embodiment, credential production device 100 includes an internal frame 130 that is configured to house print ribbon cartridge 110 and transfer ribbon cartridge 114 after print ribbon 112 is loaded onto print ribbon cartridge 110, after transfer ribbon 116 is loaded onto transfer ribbon cartridge 114 and both cartridges are inserted into credential production device 100. When print ribbon cartridge 110 is inserted into internal frame 130 of credential production device 100, embodiments of print ribbon cartridge 110 also receive a printhead housing 132 contained in internal frame 130. Printhead housing 132 houses a printhead assembly having a printhead 108, which is a credential processing device component. Print ribbon cartridge 110 allows printhead 108 to rotate about a rotation path such that a burn element on printhead 108 faces and applies pressure on print platen 109 and therefore places second side 126 of print ribbon 112 in contact with second side 128 of transfer ribbon 116.

In one embodiment, credential production device 100 includes a print ribbon sensor 129 and a transfer ribbon sensor 131. Print ribbon sensor 129 is configured to detect different color frames or panels of print ribbon 112. The frames or panels repeat in a sequence or group consisting of a yellow, magenta and cyan frames or panels. In addition, print ribbon 112 can include a black resin frame or panel can be provided in the sequence of color frames or panels, if desired. Print ribbon sensor 129 detects the colored frames or panels for controller 107, which uses signals derived from the sensed frames or panels to control motor 134. Motor 134 feeds print ribbon 112 in a direction indicated by arrows 135. Transfer ribbon sensor 131 is configured to sense transition marks that separate substantially clear or transparent panels along the length of transfer ribbon 116. Transfer film sensor 131 detects the transition marks for the controller 107, which uses signals derived from the sensed transition marks to control motor 136. Motor 136 feeds transfer ribbon 116 in a direction indicated by arrows 137.

While motors 134 and 136 are operating, printhead 108 applies pressure against print platen 109 such that printhead 108 is in contact with first side 125 of print ribbon 112 and brings print ribbon 112 in contact with second side 128 of transfer ribbon 116. In general printhead 108 is a thermal printhead having burn elements. Burn elements on printhead 108 transfer a reverse image onto a panel of transfer ribbon 116 using print ribbon 112. In other words, transfer ribbon 116 is configured to receive an image as printed by printhead 108 using print ribbon 112. Printhead 108 prints each panel of transfer ribbon 116 while oriented in a direction that is perpendicular to a credential substrate path 138. The reverse image on the panel of transfer ribbon 116 is then moved towards credential substrate path 138 for transferring the reverse image to a credential substrate 140.

In another embodiment, image transfer section 105 includes a substrate input 142, a substrate transport 143, a transfer mechanism 144 and a substrate output 145. Credential substrates 140 are received by substrate transport 143 from substrate cartridge 104 at substrate input 142. Substrate transport 143 feeds credential substrates 140 individually along substrate path 138. Substrate path 138 is substantially flat between substrate input 142 and substrate output 145 to avoid any bending or damaging of substrates 140, particularly when they are in the form of rigid or semi-rigid plastic substrates used to form identification cards. Substrate transport 143 includes substrate feed rollers 146 that are driven by a motors through gear and pulley arrangements. It should be noted that in some embodiments separate motors can be used for different stages of substrate transport through credential production device 100. For example, a motor can be used to drive the feeding of a substrate 140 through substrate input 142 and another motor can be used to drive the feeding of substrate 140 through the remaining substrate path 138 in credential production device 100.

When transfer ribbon cartridge 114 is inserted into credential production device 100, as previously discussed, embodiments of transfer ribbon cartridge 114 also receives a portion of a transfer roller assembly 147 (FIG. 2) that includes a transfer roller 148, which is a credential production device component, illustrated in FIG. 3. Transfer roller 148 is a roller capable of being heated and capable being cooled. Transfer ribbon cartridge 114 allows transfer roller assembly 147 to move and therefore allows transfer roller 148 to apply pressure on a platen 149. During image transfer, transfer roller 148 is in contact with first side 127 of transfer ribbon 116 and presses transfer ribbon 116 and substrate 140 against platen 149 such that the reverse image printed on transfer ribbon 116 is transferred onto a bottom side 141 of substrate 140. Transfer roller 148 uses heat and pressure to transfer the reverse image printed on transfer ribbon 116 onto substrate 140.

In one embodiment, the credential production device 100 includes a data reader/writer 150 configured to read and/or write data to the substrate 140. Exemplary data reader/writers 150 include magnetic stripe reader/writers configured to read data from and/or write data to a magnetic stripe on the credential substrate 140, a bar code reader/writers configured to read data from a barcode on the substrate 140 and/or write data to the barcode on the substrate 140, a memory reader/writer, such as a smartcard encoder, configured to read data from a memory of the substrate 140 and/or write data to the memory of the substrate 140, and other data reader/writers. In one embodiment, the data reader/writer 150 is positioned above the processing path 138 and is configured to read and/or write data at a top surface of the substrate 140.

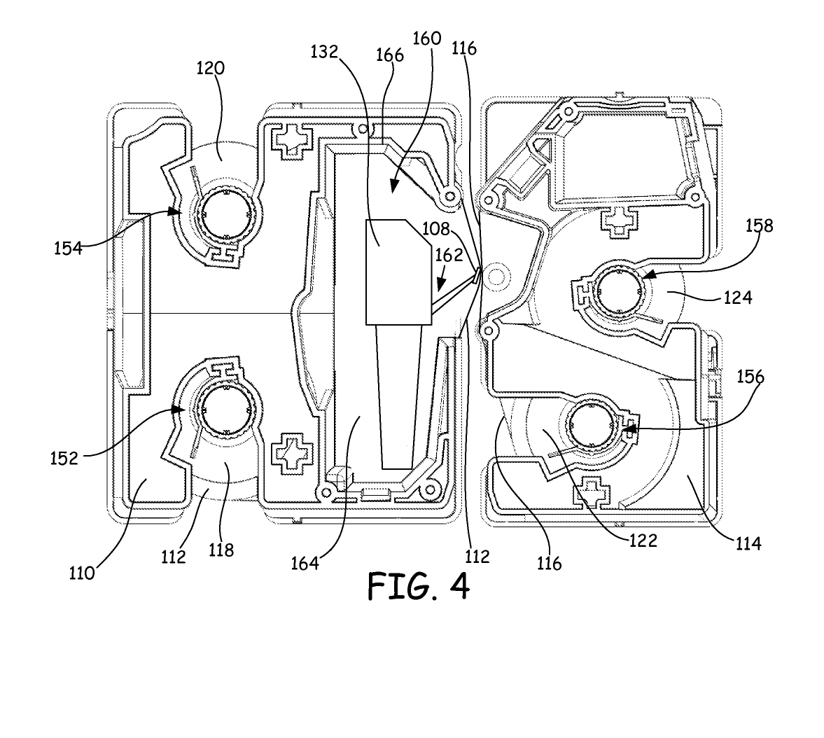

FIG. 4 illustrates a rear plan view of print ribbon cartridge 110 and transfer ribbon cartridge 114 with a printhead housing 132 engaged with print ribbon cartridge 110. In FIG. 4, print ribbon cartridge 110 includes a loaded supply of print ribbon 112. The supply of print ribbon 112 includes supply spool 118 and take-up spool 120. The supply spool 118 is positioned in a supply spool receiver 152 and take-up spool 120 is positioned in take-up spool receiver 154. Transfer ribbon cartridge 114 includes a loaded supply of transfer ribbon 116. The supply of transfer ribbon 116 includes supply spool 122 and take-up spool 124. The supply spool 122 is positioned in a supply spool receiver 156 and take-up spool 124 is positioned in a take-up spool receiver 158.

As illustrated in FIG. 4, print ribbon cartridge 110 includes a printhead housing receiver 160. Printhead housing receiver 160 is configured to receive printhead housing 132 including a printhead assembly 162 having a printhead 108 when print ribbon cartridge 110 is inserted into internal frame 130 of credential production device 100 (FIG. 2). Printhead housing receiver 160 includes a first end 164 that includes the front support wall of print ribbon cartridge 110 and a second end opposite the first end that is open. Printhead housing receiver 160 also includes opposing side ends that are open, a bottom end that is open and a top end 166 that includes a plurality of guides and rollers for feeding print ribbon 112 from supply spool 118 to take-up spool 120. The open side end of print ribbon cartridge 110 that is adjacent transfer ribbon cartridge 114 allows printhead assembly 162 to rotate about a rotation path such that printhead 108 faces and can apply pressure on print platen 109 and therefore places print ribbon 112 in contact with transfer ribbon 116. Print ribbon cartridge 110 allows such a configuration by including print ribbon having a width that extends across the open side end of printhead housing receiver 160 that faces transfer ribbon cartridge 114. In FIG. 4, printhead assembly 162 is in a print position. In a print position, printhead assembly 162 is rotated to pinch print ribbon 112 and transfer ribbon 116 against print platen 109. As illustrated, such an action moves print ribbon 112 to be in contact with transfer ribbon 116.

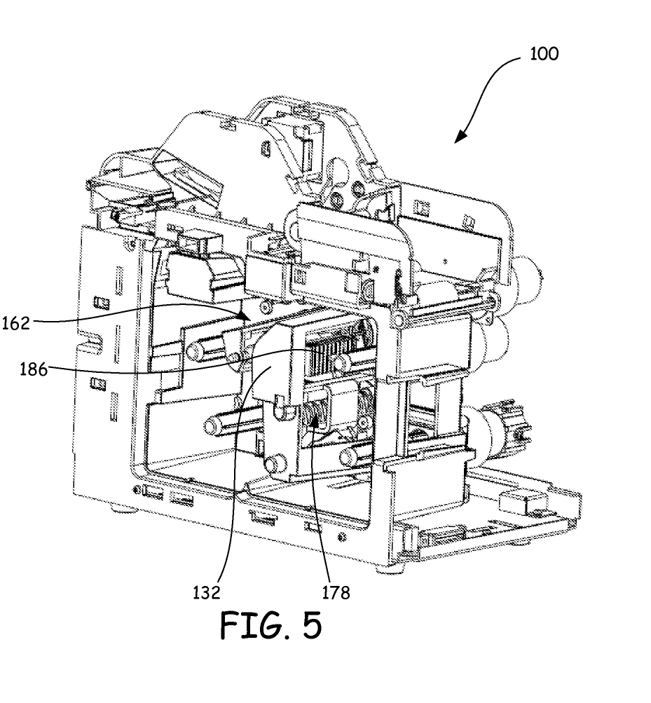

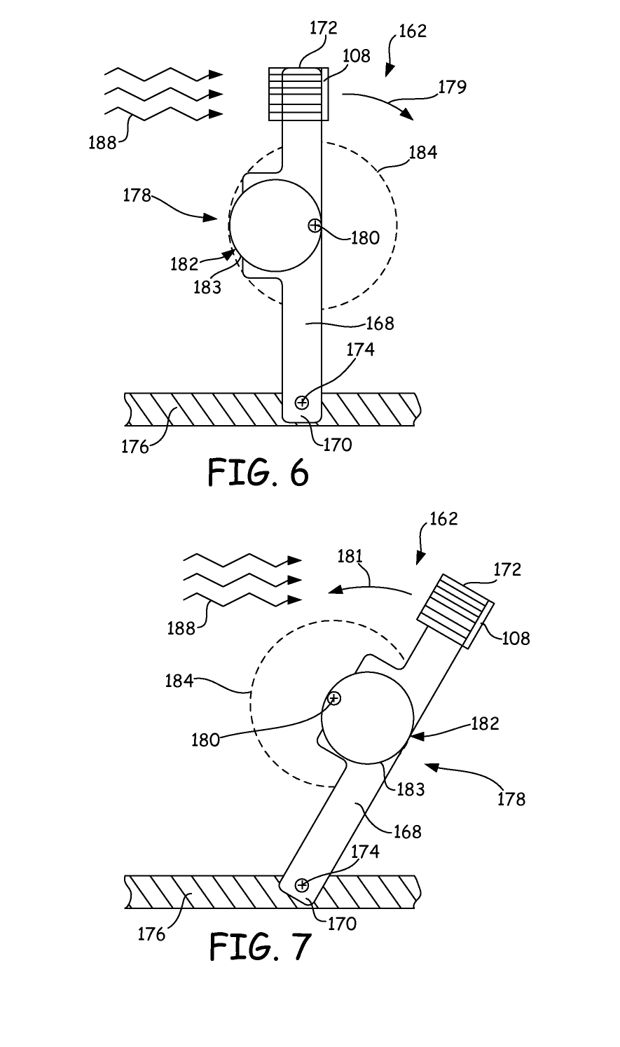

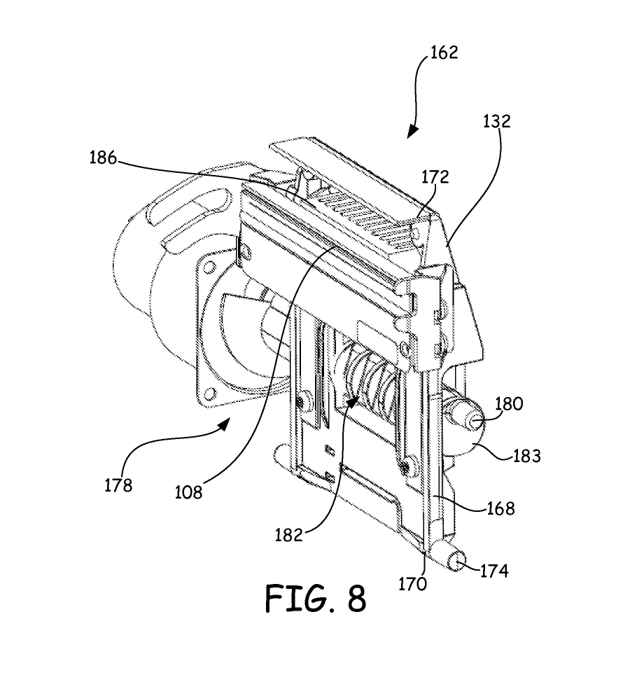

FIG. 5 illustrates a front perspective view of credential production device 100 including printhead housing 132 and printhead assembly 162 with enclosure 101 (FIG. 1) removed. In FIG. 5, both print ribbon cartridge 110 and print ribbon cartridge 114 have also been removed to clearly illustrate printhead housing 132 and printhead assembly 162. Printhead assembly 162 is also schematically illustrated in simplified representations in FIGS. 6 and 7 and perspectively illustrated in FIG. 8.

With reference to FIGS. 5, 6, 7 and 8, printhead assembly 162 includes a support member 168 having a first end 170 and a second end 172. Printhead assembly 162 includes a pivotable coupling 174 attached to a fixed frame 176 at first end 170. Pivotable coupling 174 allows support member 168 to be rotatable relative to frame 176. Attached to the second end 172 of support member 168 includes printhead 108. Between first end 170 and second end 172, printhead assembly 162 includes an actuation mechanism 178 coupled to support member 168. Actuation mechanism 178 is configured to pivot support member 168 about frame 176 to move printhead 108 from an idle position as illustrated in FIGS. 5, 6 and 8 to a print position as illustrated in FIGS. 4 and 7 (also illustrated by arrow 179 in FIG. 6). In addition, actuation mechanism 178 is configured to pivot support member 168 about frame 176 to move printhead 108 from a print position as illustrated in FIGS. 4 and 7 to an idle position as illustrated in FIGS. 5, 6 and (also illustrated by arrow 181 in FIG. 7). In FIGS. 4 and 7, while in the print position, printhead 108 is located at least partially between supply spool 118 and take-up spool 120 and is in contact with print ribbon 112. However, in an idle position as illustrated in FIG. 5, printhead 108 is located at least partially between where supply spool 118 and take-up spool 120 would be located and is spaced apart from print ribbon 112.

Actuation mechanism 178 is pivotably coupled to support member 168 at pivot point 180. In FIGS. 5, 6, 7 and 8, actuation mechanism 178 is illustrated as a cam mechanism 182. Cam mechanism 182 includes a cam element 183 that rotates about pivot point 180 along a cam path 184. By following cam path 184, cam mechanism 182 is configured to rotate support member 168 about the pivotable coupling 174 that is coupled to frame 176 to place printhead assembly 162 into an idle position or into a print position. It should be noted that actuation mechanism 178 can be other types of mechanisms other than a cam mechanism. Actuation mechanism 178 can be any type of mechanism that can rotate support member 168 into an idle position and into a print position.

With reference to FIGS. 5, 6, 7 and 8, printhead assembly 162 also includes a heat sink 186. Heat sink 186 is coupled to printhead 108. Heat sink 186 is configured to dissipate heat generated by a burn element on printhead 108. Heat sink 186 includes a plurality of fins that utilize convectional airflow 188 from the environment. As illustrated in FIG. 2, the lack of a side enclosure in print ribbon cartridge in combination with the extensive vent located on the outer surface of the housing 101 of credential production device 100 allows airflow from the environment to easily reach printhead 108. Heat sink 186 efficiently uses this airflow to quickly cool printhead 108.

Although the present invention has been described with reference to preferred embodiments, workers skilled in the art will recognize that changes may be made in form and detail without departing from the spirit and scope of the invention.

What is claimed is:

1. A credential production device comprising:
a frame;
a printhead assembly comprising:
a support member having first and second ends;
a pivotable coupling attaching the first end of the support member to the frame;
a printhead coupled to the second end of the support member; and
an actuation mechanism coupled to the support member between the first end and the second end, the actuation mechanism configured to pivot the support member about the frame to move the printhead from an idle position to a print position.

2. The credential production device of claim 1, further comprising a supply of print ribbon, wherein the printhead pinches the print ribbon when in the print position.

3. The credential production device of claim 2, further comprising a transfer ribbon and a print platen, wherein the transfer ribbon and print ribbon are pinched between the printhead and the print platen when the printhead is in the print position.

4. The credential production device of claim 2, wherein the supply of print ribbon extends from a supply spool to a take-up spool, the printhead is located at least partially between the supply spool and the take-up spool and spaced apart from the print ribbon when in the idle position.

5. The credential production device of claim 4, further comprising a heat sink coupled to the printhead.

6. The credential production device of claim 1, wherein:
the actuation mechanism comprises a cam mechanism that is coupled to the support member and configured to rotate the support member; and
the support member pivots about the pivotable coupling in response to rotation of the cam mechanism.

7. A method of engaging a printhead assembly to print in a credential production device, the method comprising:
providing a frame;
providing a printhead assembly having:
a support member having a first and second ends;
a pivotable coupling attaching the first end of the support member;
a printhead coupled to the second end of the support member; and
pivoting the support member about the frame to move the printhead along an arc from an idle position to a print position.

8. The method of claim 7, wherein pivoting the support member further comprises applying pressure onto a supply of print ribbon.

9. The method of claim 8, wherein pivoting the support member further comprises pinching the supply of ribbon and a supply of transfer ribbon between the printhead and a print platen when the support member is in the print position.

10. The method of claim 7, further comprising dissipating heat from the printhead using a heat sink attached to the printhead.

11. The method of claim 7, wherein pivoting the support member comprises pivoting the support member with a cam mechanism.

12. A credential production device comprising:
a supply of print ribbon;
an image receiver, the image receiver being adjacent to the supply of print ribbon;
a printhead assembly comprising:
a support member having first and second ends;
a pivotable coupling attaching the first end of the support member to a frame;
a printhead coupled to the second end of the support member; and
an actuation mechanism coupled to the support member between the first end and the second end, the actuation mechanism configured to pivot the support member about the frame to move the printhead from an idle position to a print position.

13. The credential production device of claim 12, further comprising a print platen, wherein the image receiver and the print ribbon are pinched between the printhead and the print platen when the printhead is in the print position.

14. The credential production device of claim 12, wherein the supply of print ribbon extends from a supply spool to a take-up spool, the printhead is located at least partially between the supply spool and the take-up spool and spaced apart from the print ribbon when in the idle position.

15. The credential production device of claim 14, wherein the printhead assembly comprises a heat sink coupled to the printhead.

16. The credential production device of claim 15, wherein the heat sink includes a plurality of fins for dissipating heat generated by the printhead.

17. The credential production device of claim 12, wherein the actuation mechanism comprises a cam mechanism that is coupled to the support member and configured to rotate the support member

18. The credential production device of claim 17, wherein the cam mechanism comprises a cam element, the cam element is configured pivot about the pivotable coupling in response to rotation of the cam mechanism.
